(19) United States
(12) Patent Application Publication
(10) Pub. No.: US 2020/0149494 A1
(43) Pub. Date: May 14, 2020

(54) DOUBLE-ACTING STIRLING ENGINES WITH OPTIMAL PARAMETERS AND WAVEFORMS

(71) Applicant: Daniel Norvin Brown, Nevada City, CA (US)

(72) Inventor: Daniel Norvin Brown, Nevada City, CA (US)

(21) Appl. No.: 16/631,126

(22) PCT Filed: Jul. 13, 2018
(86) PCT No.: PCT/IB2018/055188

§ 371 Date: Jan. 14, 2020

(30) Foreign Application Priority Data
Jul. 14, 2017 (IN) 201721025134

(51) Int. Cl. F02G 1/044

(52) U.S. Cl. CPC F02G 1/044; F02G 2244/50

(57) ABSTRACT

The price per performance advantages of double-acting Stirling engines have long been known, and recent experiments have demonstrated the performance and behavior advantages of Stirling engines which involve optimal parameters, such as an optimal phase angle between the pistons. Herein disclosed are new Stirling engine designs which permit both of these advantages to be achieved at once, as well as other benefits such as compactness, simplicity, reliability and lower cost.

### FIELD OF THE INVENTION

This invention relates to Stirling engines, a type of heat engine capable of converting heat energy into mechanical energy, which can alternatively operate as a heat pump. This invention relates more specifically to double-acting Stirling engines, which generally offer a better power per moving parts ratio than conventional Stirling engines.

### BACKGROUND OF THE INVENTION

There is an unmet need for an economical, safe and reasonably efficient method to convert heat from any source into mechanical motion and/or electric power. Internal combustion engines are common, but they cannot run from renewable energy sources such as sunlight, geothermal, or waste heat. Stirling engines are one of the most efficient heat engines currently known, but they're not yet economically viable. Potential applications for economically viable Stirling engines include conversion of solar, geothermal and waste heat, as well as heat from any conventional, bio-waste, bio-fuel or nuclear fuel sources. Each of the above market areas has vast potentials. In all markets the key to economic viability is to significantly improve the power per cost ratio of the engine, preferably while also increasing the performance and reliability.

One significant step forward in Stirling engine development was the well-known Rinia configuration, first discovered by Sir William Siemens in 1863, which allowed Stirling engines to be built with double-acting pistons. This strategy multiplied the power output and also improved the power per cost ratio. This engine was also the first of its kind to couple the power (or expansion) stroke happening in one part of the engine to a compression stroke happening elsewhere, allowing some of the energy delivered from the first to supply the energy required for the second. This greatly smoothed the engine's power output, and it also helped that there were four such power strokes, evenly distributed throughout the 360 degrees of crankshaft rotation. Prior to this, Stirling engines delivered one power stroke per revolution, 180 degrees away from the compression stroke, so a flywheel was essential to make the engine work at all.

While the Rinia engine brought significant advantages, it also introduced some disadvantages. One of these is an inclination towards thermal losses in the pistons and cylinders of the engine, which are hot on one side and cool on the other, inducing a steep thermal gradient along the sides of the associated cylinders. Assuming the cylinders are metallic, the thermal losses could be substantial. The case of the pistons is similar, but there the designer is more free to use insulating materials, minimizing the losses.

The double-acting Rinia configuration with 4 pistons is shown in prior-art FIG. 1A. Expansion space 1 associated with a given piston 6 is connected through a working gas conduit formed by heat exchangers (heater 2, regenerator 3 and cooler 4) to compression space 5 associated with an adjacent piston 6. The above combination of components, together with some means to modulate the pistons with some desired phase offset angle, is hereafter referred to as a “cyclic set”, as it is sufficient to generate one Stirling cycle per crankshaft revolution. The FIG. 1A engine includes four cyclic sets, so it can be called a four-cycle engine. It's generally understood that related configurations with fewer or more cyclic sets are possible.

Note that the Stirling engine literature commonly identifies heaters, regenerators and coolers with the letters H, R, & K, while the expansion and compression spaces are identified with the letters E & C, respectively. To improve readability for those familiar with said literature, this practice is also followed within this document.

In this document the term “configuration” refers to a particular manner of topologically connecting pistons, spaces and heat exchangers together to create a Stirling engine, including specific phase offset angles between the adjacent pistons. The term “arrangement” refers to some manner of positioning the components that make up a given configuration without altering the topological connections or phase offsets. To illustrate the distinction, FIGS. 1A and 1B show two different arrangements of the same 4-piston Rinia configuration. Also in this document, “double acting piston” refers to any piston in which both sides are utilized. “Double acting engine” refers to any engine in which all of the pistons are double acting. “Double acting configuration” is a configuration that can be used to create double acting Stirling engines.

In U.S. Pat. No. 4,199,945 to T. Finkelstein, all but one of the engines presented in that document were various free-piston arrangements of the Rinia configuration, with the opposing pairs of pistons directly coupled to each other so that every power stroke could directly power every compression stroke through “internally balanced forces”, meaning forces which are internal to the double-pistons, without intervening linkages. The upper half of FIG. 6 disclosed an apparently new 4 cycle configuration which is herein replicated as prior-art FIG. 2, excepting that in that document, the engine was presented as a dual free-piston design without any crankshaft or linkages. Again in this configuration the power strokes directly drive the compression strokes. In U.S. Pat. No. 7,891,184 to A. Gimsa, the same Stirling engine configuration is again presented, this time with a crankshaft, an attached rotary motor/generator, and linking members. Gimsa identified the 4 gas circuits/cyclic sets as Z1-Z4; his nomenclature is replicated in FIG. 2 to make the correspondences more evident. One innovative advantage of the FIG. 2 engine is that four Stirling cycles are generated through the motion of two double-pistons, significantly reducing the number of distinct moving parts, and these four cycles are again evenly distributed throughout the rotation of the crankshaft.

The situation with thermal losses is improved in the Finkelstein/Gimsa design with the expansion spaces in one cylinder and the compression spaces in another. This allows insulation to be placed between the hot and cold cylinders, but there will still be some losses, at least in the rod that connects the two pistons together.

Another significant step in Stirling engine development was a series of long-overdue experimental measurements to determine the optimal phase angle and volume ratio parameters for a Stirling engine, which determine the associated volumetric waveforms. Clearly some waveforms will produce better engine performance than others, but it was long unclear which would work best. In the 2014 book “Stirling Cycle Engines—Inner Workings and Design”, Allan J. Organ documented the experiments of Geoff Vaizey and Ian Larque, which measured the optimal parameters for a particular variable test engine. In that Beta-type engine the “volume ratio” refers to the volume swept by the piston divided by the volume swept by the displacer, which was optimized at about 0.75, and the optimal phase offset angle was determined to be about 50°. These parameters lead to the volumetric waveforms shown in FIG. 2, with dashed curve 10 representing the volume in the expansion space on the hot side of the displacer, dotted curve 11 for the volume in the compression space on the cold side, and solid curve 12 showing the sum or total volume in these two spaces. The 50° offset between the displacer and the piston, called the Beta angle in that engine type, is visible in FIG. 2 as the offset between the peaks in the dashed expansion space curve 10 and the solid total volume curve 12.

These same waveforms can be generated by an Alpha-type Stirling engine, permitting the advantages of a double-acting engine. That engine would require one piston to generate the expansion space curve and another to generate the compression space curve. As is also visible in FIG. 2, the required phase offset between these two pistons would then be about 132°, equivalent to the phase offset between dashed expansion space curve 10 and dotted compression space curve 11, which is referred to as the alpha angle in the literature. Another standard practice is to define the volumetric ratio differently for alpha engines, as the ratio between the volume swept in the compression space to that swept in the expansion space (commonly referred to as the kappa ratio). While the optimal waveforms are defined with different numeric parameters in the different engine types, the underlying waveforms presumably remain about the same.

The observed characteristics of engines with optimal or near-optimal waveforms include improved performance, an eagerness to start and an ability to keep running long after the incoming heat has been completely disconnected. These characteristics are desirable as well as valuable for any type of engine.

Unfortunately, one significant disadvantages of both the Rinia and Finkelstein/Gimsa designs is that neither one readily permits the phase offset or alpha angle to be optimized, for reasons which will soon be made clear.

### BRIEF SUMMARY OF THE INVENTION

A first objective of this invention is to bring together the performance and behavior advantages of Stirling engines which generate near-optimal waveforms with the cost/performance advantages of double-acting engines. A second objective is to have internally balanced forces as much as possible within the engine. A third objective is to keep the number of moving parts to a minimum, and as much as possible to make the parts simple and low-cost. A fourth objective is to minimize thermal losses, and a fifth objective is to make the design as compact as possible to improve the specific power of the engine.

### BRIEF DESCRIPTION OF THE FIGURES

FIGS. 1A and 1B show two different prior-art arrangements of the 4-piston Rinia configuration.

FIG. 2 shows a prior-art configuration which appears in the Finkelstein and Gimsa patents.

FIG. 3 is a graph showing the waveforms found to be optimal for the Vaizey-Larque test engine.

FIGS. 4A and 4B show two alpha-type Stirling engines, both capable of matching the optimal waveforms for the Vaizey-Larque test engine.

FIGS. 5A, 5B and 5C show three different arrangements of the new “supplementary configuration” engine capable of generating four Stirling cycles with optimal waveforms.

FIG. 5D is an addendum to FIG. 5C; together they shows how two of the FIG. 5C engines can be used to generate 8 power strokes per revolution while also minimizing engine vibrations.

FIG. 5E shows how two of the FIG. 5C engines can be used to generate 8 evenly-spaced power strokes per revolution with only 9 moving parts.

FIG. 6A illustrates a first arrangement of the “simple mirrored configuration” engine with radially-placed pistons, capable of generating two Stirling cycles with optimal waveforms.

FIG. 6B illustrates a second arrangement of the “simple mirrored configuration” engine with parallel piston cylinders.

FIG. 6C illustrates an arrangement of the “crossed-over mirrored configuration” engine, also capable of generating two Stirling cycles with optimal waveforms.

FIG. 7A illustrates a third compact arrangement of the “simple mirrored configuration” engine with rotary pistons involving two piston seals on each piston.

FIGS. 7B and 7C are magnified views showing certain details of the FIG. 7A engine.

FIG. 7D shows an engine-balancing method for engines with rotary pistons.

FIG. 8A illustrates a fourth, ultra-compact arrangement of the “simple mirrored configuration” engine with rotary pistons and only one piston seal on each piston.

FIG. 8B illustrates an active method of cooling the rotary bearings associated with a rotary expansion piston.

FIG. 8C shows a second engine-balancing method for engines with rotary pistons.

FIGS. 9A-9H illustrate the step-by-step motions of the engine of FIG. 7A.

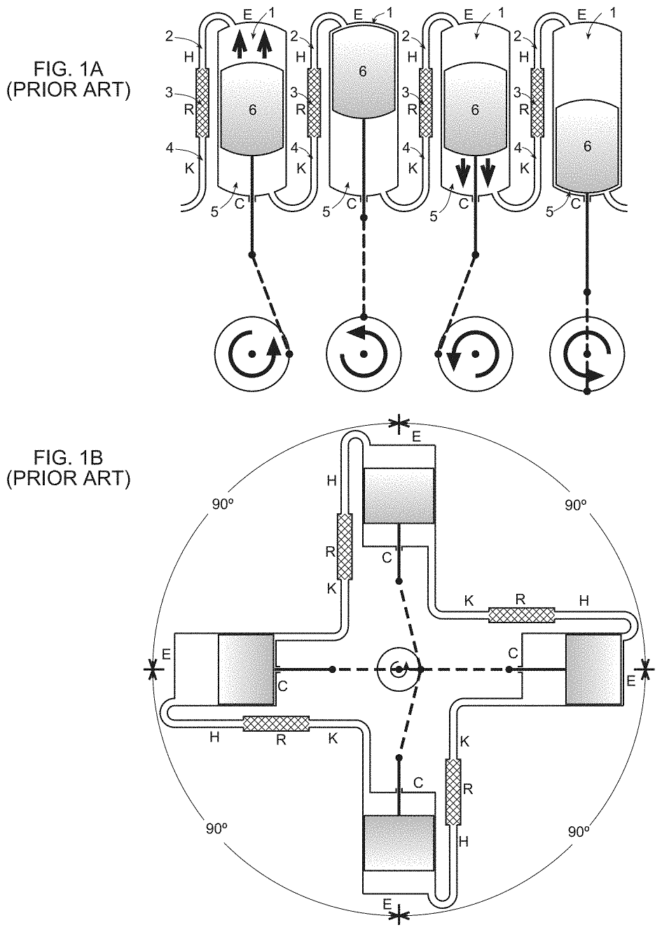

### DETAILED DESCRIPTION OF THE PREFERRED EMBODIMENTS

In pursuit of the first objective of generating optimal waveforms with a double-acting engine, applicant tried modifying a Rinia configuration engine to include an alpha angle closer to the observed optimal alpha angle of 132°. In the aforementioned book by Alan J. Organ, the author in fact explicitly suggested this step, writing: “a better choice for the Rinia would now appear to be three cylinders with alpha=120 degrees.” But this does not work, because that author did not correctly understand all the issues, nor are there any literature references known to applicant which present a correct understanding of them.

### New Principles Behind the Invention

After much analysis, applicant has established a “supplementary equivalence principle” which is illustrated in FIGS. 4A & 4B. According to this principle, a Stirling engine with a given phase offset angle and matching compression and expansion spaces, such as the engine shown in FIG. 4A, will generate identical waveforms as a Stirling engine with a supplementary phase offset angle and mis-matched spaces, such as that shown in FIG. 4B. Here the words “matched” and “mis-matched” refer to whether the compression and expansion spaces are on the same side of their respective pistons or not, relative to the driving crankshaft. The FIG. 4A engine involves matched spaces because the compression and expansion spaces are both on the far side of their respective pistons, away from the crank shaft. The FIG. 4B engine involves mis-matched spaces because the compression space is on the near side of its piston while the expansion space is on the far side of its piston. “Supplementary” is a conventional geometric term: two angles are supplementary if their sum is 180°. The phase offset angle between the pistons in FIG. 4A is 132°, so the supplementary angle is 48°, as shown in FIG. 3B. By visualizing the synchronous rotation of the crankshafts in the FIGS. 4A & 4B engines, it can be seen that the volumes within the compression and expansion spaces in these two engines will always be identical. It can be further seen that this will still hold even if the phase angle in FIG. 4A is increased or decreased by some amount, provided the phase angle in FIG. 4B is also adjusted by the same amount, maintaining the supplementary relationship between the two engines.

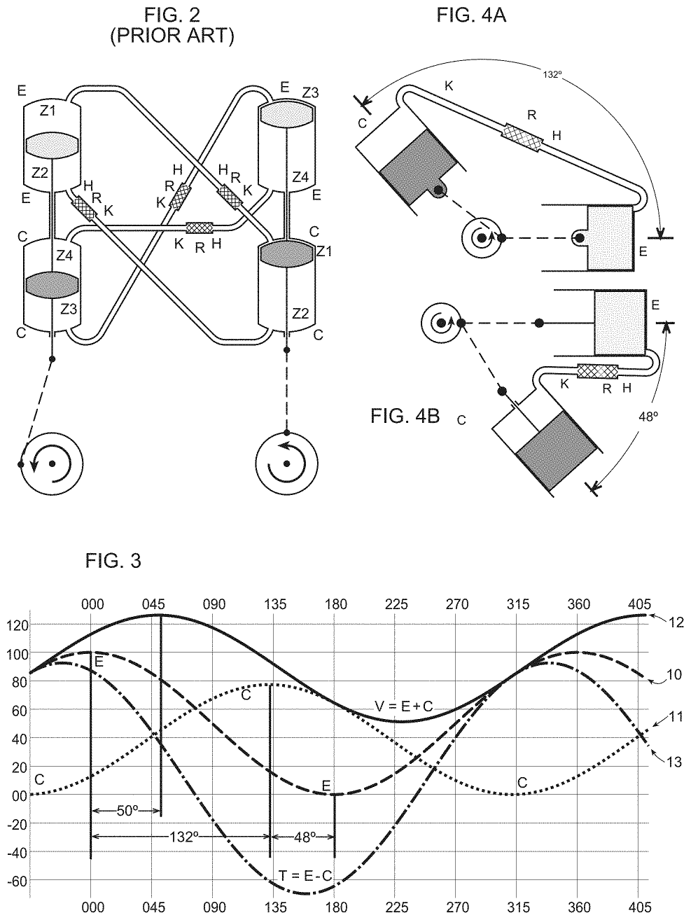

Note that both of the engines shown in FIGS. 4A and 4B can be used to generate the precise waveforms shown in FIG. 2, provided that the swept volume of the compression space is reduced in relation to that in the expansion space so as to also obtain the desired volume (kappa) ratio. This can be done by adjusting the areas of the modulating piston faces, or by adjusting the stroke lengths, or some combination of the two.

In order to minimize confusion when discussing these issues, it is helpful to distinguish between the geometric alpha angle, which is always the angle between the pistons in an alpha engine, and the effective alpha angle, which with mis-matched piston faces will be 180 degrees minus the geometric alpha angle. In the FIG. 4A engine, the geometric alpha angle and the effective alpha angle are both 132 degrees. In the FIG. 4B engine, the geometric alpha angle is 48 degrees, but because of the mis-matched faces, the effective alpha angle is 180−48 degrees or 132 degrees.

Because the Rinia configuration involves mis-matched spaces rather than matched spaces, a notable consequence of the supplementary equivalence principle is that in order to achieve an effective alpha angle of around 132 degrees, a geometric alpha angle of around 48 degrees will be needed, meaning that the best-possible Rinia configurations will have either 7 or 8 pistons. An 8 piston Rinia engine will have a geometric alpha angle of 360/8=45 degrees, but it will generate an effective alpha angle of 180−45=135 degrees, very close to the desired 132 degrees.

### Supplementary Configuration Embodiments

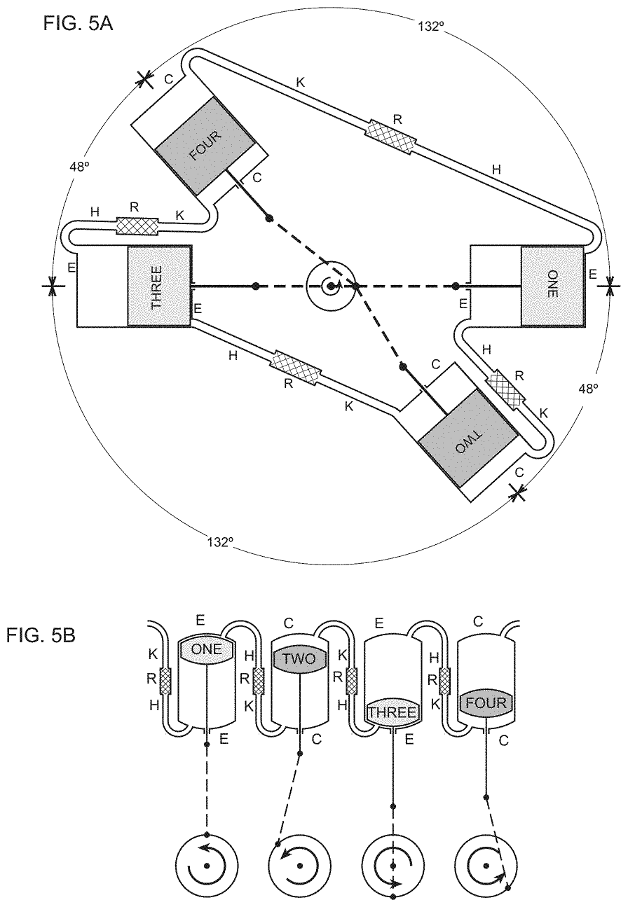

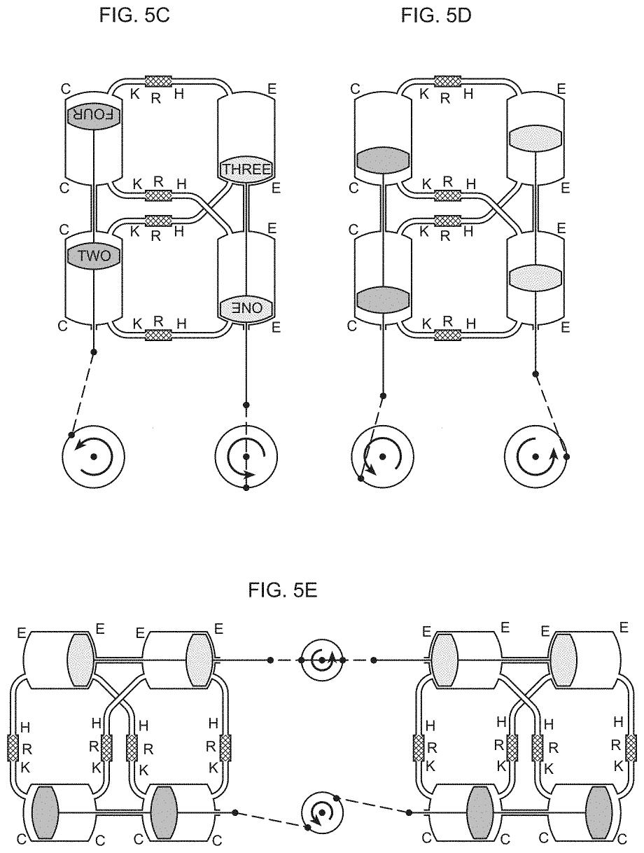

Once the supplementary equivalence principle is understood, it follows that two pairs of supplementary cyclic sets can be combined, yielding the engines shown in FIGS. 5A and 5B. These two figures show two arrangements of a new Stirling engine configuration with four double-acting pistons. The configuration puts together two cyclic sets with acute phase angles like the FIG. 4B engine with another two cyclic sets with obtuse phase angles like the FIG. 4A engine.

In FIG. 5A the pistons are shown in a radial arrangement around a single crankshaft, connected to a single crankpin. FIG. 5B represents the same configuration with the pistons arranged in parallel, and with separate crankpins honoring the same phase offsets. The FIG. 5B engine arrangement would be much more easily varied, since adjusting the phase angle would simply mean adjusting the angular placement of the crankpins on the crankshaft, which would be much easier than adjusting the angle between the radial piston cylinders.

The primary advantage of this new supplementary configuration is that the phase offsets can be easily and continuously varied to experimentally find the optimal waveforms for this particular engine, and all four cyclic sets can then generate those waveforms for the life of the engine.

Note that in this configuration, two of the four pistons will be at the hot-side engine temperature, while the other two will be at the cold side temperature. This is in contrast to the Rinia configuration, in which each of the pistons has one side hot and the other side cold. Another advantage of this configuration, therefore, is that lower thermal losses will result through conductivity within the pistons and the enclosing cylinders. On the other hand, the two pistons at the hot-side engine temperatures will require piston seals that can fully handle those high temperatures. Depending on the engine temperatures, graphite is perhaps the best material for those seals.

The primary advantage of the FIG. 5A engine arrangement is that it's possible to vary the power output from the engine by adjusting the radius of the shared single crankpin, whereas this is practically impossible in the other arrangements.

A disadvantage of both the 5A and 5B arrangements is that the hottest areas in the engine near the heaters and expansion spaces are physically near to the coolest areas in the engine, surrounding the coolers and compression spaces.

This disadvantage is overcome in the preferred embodiment shown in the FIG. 5C arrangement, which not only cleanly segregates the hot areas from the cooler ones, it also eliminates half of the kinematic linkages by stacking the piston cylinders together to form double-pistons, comparable to the arrangement shown in prior-art FIG. 2. Here the four pistons are labeled with numbers to make it easier to follow where each appears in each of these three figures.

One characteristic of the supplementary configuration engines is that the power output peaks are not distributed at equal intervals throughout the crankshaft rotation. For example if an effective alpha angle of 132 degrees is desired in all four cyclic sets, then the output power will peak at 0, 48, 180 and 228 degrees. These power strokes will coincide with compression strokes, so the power output will be smooth and steady enough for almost all purposes, but if a case arises in which extremely smooth power output is required, then the arrangement of two such engines shown in the adjoining FIGS. 5C & 5D can be used, with the effective alpha angle set at 135 degrees and the phase offset between the two engines set at 90 degrees. The first engine will then have power output peaks at 0, 45, 180 and 225 degrees, while the second engine will have peaks at 90, 135, 270 and 315 degrees, resulting in 8 power output peaks per revolution, evenly spaced at 45 degree intervals. Such an engine should also be extremely easy to start, if not self-starting. FIGS. 5C & 5D are drawn with a single crankshaft in mind, but a slight modification of this arrangement, not shown, would put all four of the cold pistons in the same plane on one side of the engine, with a 90° “V” between one double piston and the other. The hot pistons would be similarly be arranged on a parallel plane, again with a 90° V between one double piston and the other, and at this point all of the double-pistons could be driven by two shared crankpins spaced 90 degrees apart.

### Mirrored Configuration Embodiments

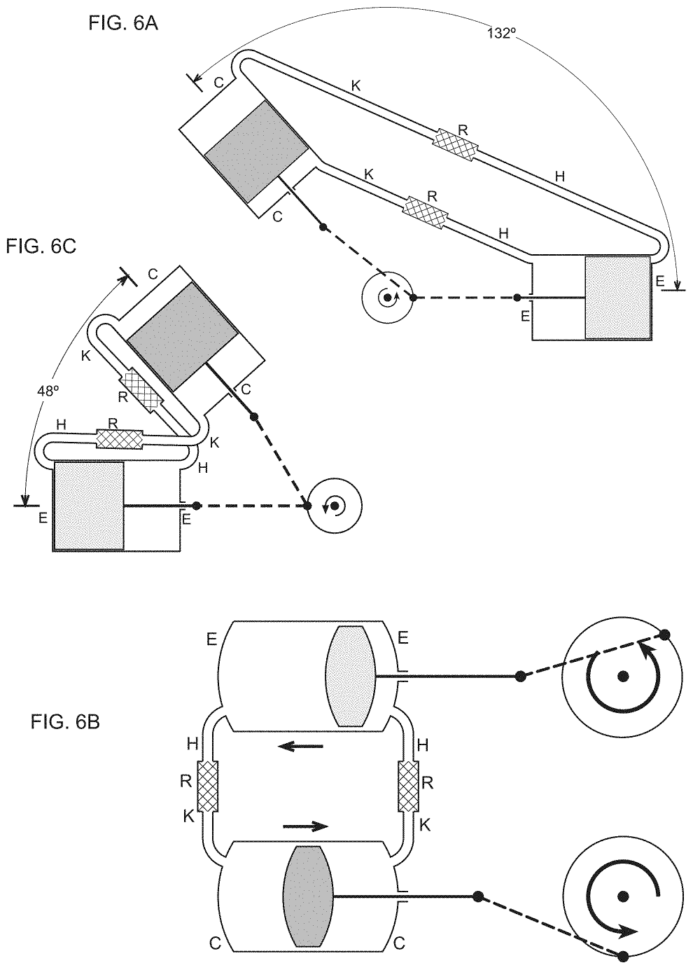

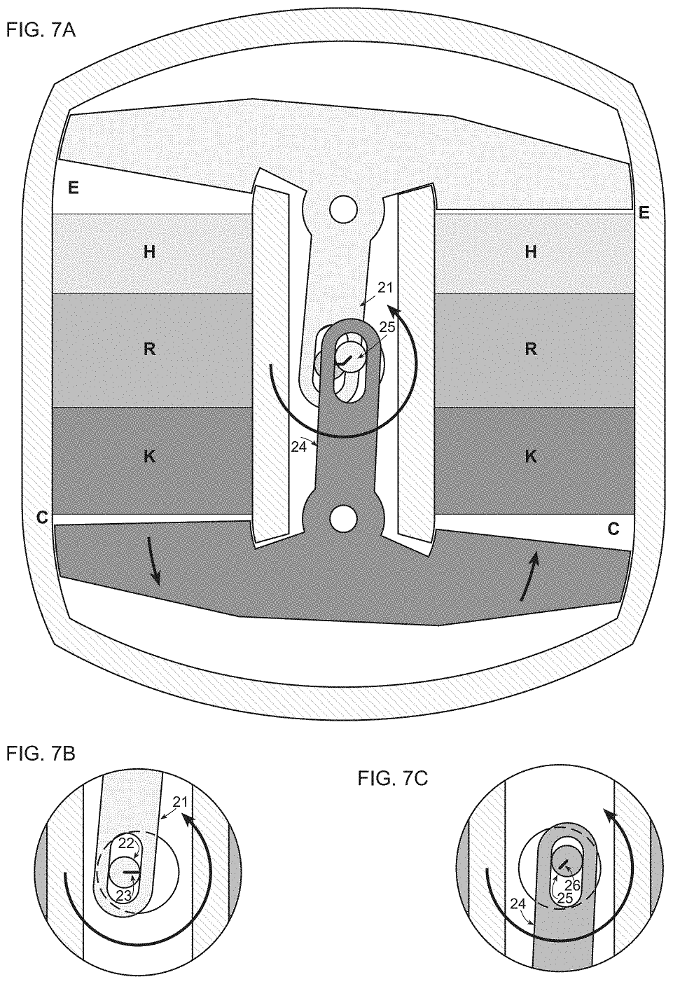

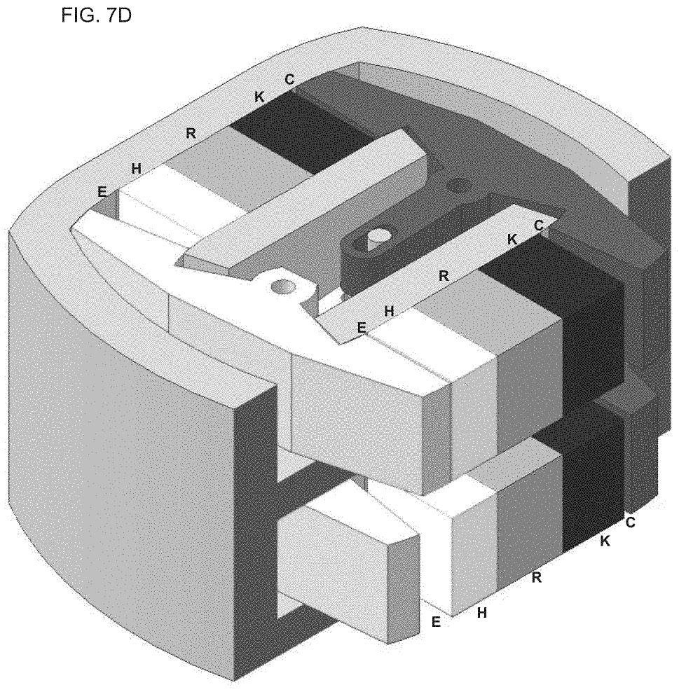

FIGS. 6A, 6B, 6C, 7A & 8A illustrate five arrangements of an exquisitely simple “mirrored” engine configuration which allows a pair of double-acting pistons to generate two sets of near-optimal or precisely-optimal waveforms, 180 degrees apart. FIGS. 6A and 6B are comparable to cyclic sets Z1 and Z2 of the prior-art FIG. 2. Note that these cyclic sets involve matching spaces, with airflow conduits which go directly where needed without crossing over each other. This can be called a simple mirrored engine configuration. FIG. 6C is comparable to cyclic sets Z3 & Z4 of the same figure; these cyclic sets involve mis-matched spaces, with airflow conduits which must cross over each other. This can be called a crossed-over mirrored engine configuration.

To anyone familiar with the prior-art FIG. 2 engine, the obvious step to take in getting it to generate optimal waveforms would be to simply adjust the phase angle between the two sets of double-pistons. However, this obvious step will not work: these prior-art references would not operate in combination for reasons now clarified by the supplementary equivalence principle, herein explained. While all four cyclic sets in the FIG. 2 engine work well enough at a geometric alpha angle of 90 degrees, any attempt to bring the phase offset between the two double-pistons towards a larger, more optimal value will result in increased performance and improved behavior from the half of the engine comprising the Z1 & Z2 cyclic sets, but it will also degrade the performance and lead to progressively uncooperative behavior in the other half of the engine comprising the Z3 & Z4 cyclic sets. And the same half improved & half degraded behavior would result from bringing the Z3 & Z4 cyclic sets toward an improved, smaller phase offset angle, although it is doubtful that anyone would have thought to try that, as the belief was that a larger geometric phase offset would improve rather than degrade the performance also in these cyclic sets.

The incompatibility can be resolved by separating the Z1 & Z2 cyclic sets from the Z3 & Z4 sets, as shown in FIGS. 6A & 6C, and then setting the geometric phase offset at different values in the two different engines, allowing the attainment of the desired effective alpha angle in both. This modification to the prior-art FIG. 2 engine had not been suggested by any source known to the applicant, and it yields two slightly different Stirling engine configurations with many useful advantages.

Once the optimal phase shift and volume ratio can be experimentally determined for a particular physically-built engine, both cyclic sets can be precisely set to those optimal parameters, without any compromises like the ones that must be made in the Siemens/Rinia configuration. If the phase angle and volume ratio are set to generate optimal waveforms in the spaces on the far sides of the two pistons, then the waveforms generated on the near side will match those optimal waveforms, minus the slightly diminished volumes due to the link rods.

In the radial piston arrangement shown in FIG. 6A, a single crankpin is linked to both pistons, allowing an engine with easily variable power levels.

In the parallel-piston arrangement shown in FIG. 6b, separate crankpins are involved, making it easier to adjust the phase offset and volume ratio by adjusting the relative positions of these two crankpins. This arrangement is also more compact than the FIG. 6A arrangement.

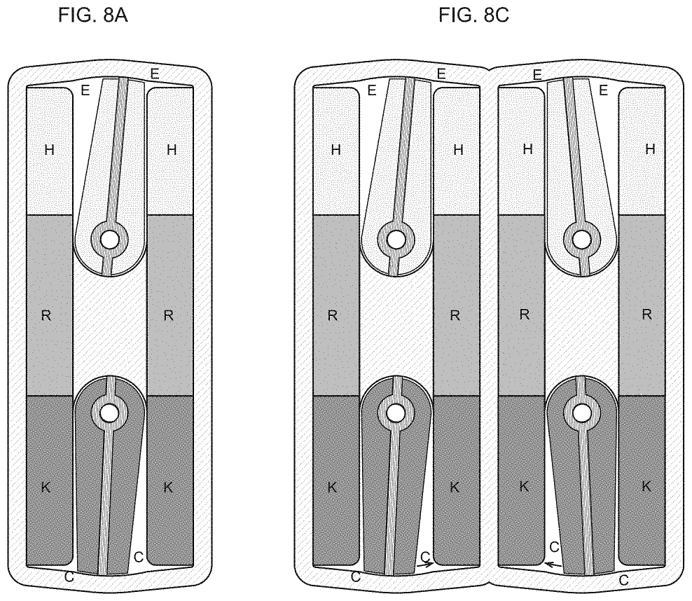

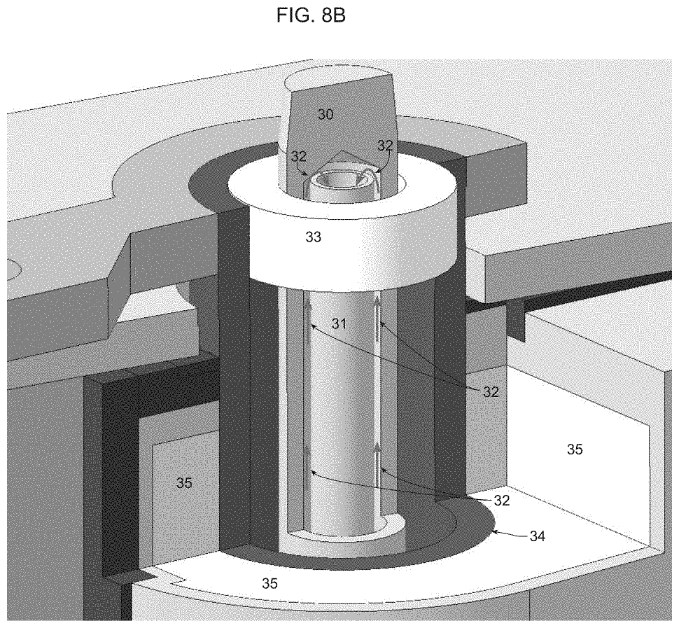

FIG. 7A illustrates the same configuration as FIG. 6a, but now in a parallel arrangement with rotary pistons. The easy adjustability of the FIG. 6b arrangement is still present, but the FIG. 7A arrangement is much more compact, leaving very little wasted space within the pressurized engine case, and thereby reducing the cost of that case. The preferred embodiment shown in the FIG. 8A arrangement is even more compact.

The FIG. 7A arrangement also avoids any slight distortion in the optimal waveforms due to the influence of the link rods. The link rods are replaced by pivot arms, yielding the advantage of precisely equal waveforms in both cyclic sets, with the slight penalty of an additional set of piston seals. The FIG. 8A arrangement again avoids the use of link rods within the expansion or compression spaces, in this case by the use of a rotary axle which extends above and/or below the pistons. The FIG. 8A arrangement also avoids the second set of piston seals and the associated friction resulting from them.

The rotary pistons involved in the FIGS. 7A and 8A arrangements also give another unique advantage: they make it possible to eliminate virtually all of the ductwork within the engine. Note that each of the piston faces in the 7A & 8A engines can be positioned to come within a small clearance distance of the adjacent surfaces. This arrangement allows virtually all of the volume which would have been in the ductwork to be replaced by a comparable volume within the heat exchangers, contributing to improved heat exchange, which should theoretically contribute towards improved performance. While this has yet to be proven within a working engine, this arrangement would allow a series of experiments to be performed by adjusting the sweep angles of the rotary pistons, resulting in more or less dead space like that which would be in the ductwork in other engines, and either verifying or correcting this hypothesis. Thus the FIGS. 7A & 8A engines at least offer another variable which can be optimized, in addition to those that were optimized in the Vaizey-Larque engine. If it's true that additional heat exchange will lead to improved performance, then the optimized FIG. 7A engine will also offer that improved performance. The possibility to eliminate the ductwork also makes possible the elimination of airflow friction through that ductwork.

One of the limitations of all known prior-art Stirling engines has been an inability to compete with two-stroke internal combustion (IC) engines, which have the often valuable attribute of a very high specific power. The extreme compactness, high power and simplicity of the 7A & 8A engines may give them the highest specific power ratio of any known Stirling engine, while bringing advantages (relative to the two stroke IC engine) of higher efficiency, more complete combustion, and complete neutrality in regard to heat source.

The FIG. 6C configuration involves cyclic sets which cross over each other due to the mismatched spaces. This configuration can therefore be called a crossed-over mirrored configuration, in contrast to the simple mirrored configuration shown in FIGS. 6A, 6B, 7A & 8A. The primary advantage of the FIG. 6C engine is that, in applications where a variable power level is required, the arrangement is considerably more compact than the one shown in FIG. 6A. This comes with disadvantages, however, in terms of a more complex layout of the heat exchangers, and a proximity between hot and cold areas, particularly near and at the crossover point. In engine applications not requiring a variable power output, the simplicity and compactness of the direct heat exchanger layouts in the figure simple mirrored arrangements make them preferable, because the greater distance between the hot and cold areas reduces the need for insulating layers, making it easier to build the engines as compact as possible while still minimizing the thermal losses.

Another advantage shared by all of the mirrored-configuration engines is that a compression stroke in one space always happens in synch with an expansion stroke on the opposite side of the same piston, internally balancing these forces directly through the body of the piston. These advantages and their many helpful consequences were enumerated at length by Finkelstein in relation to the FIG. 2 engine, and these advantages are fully retained even though the FIG. 2 engine has been split into two halves.

While there are only two power strokes per crankshaft revolution with all of the mirrored configuration engines, the fact that they coincide with compression strokes means that the power output will still be quite even, far better than the single cycle engines. For applications requiring additional smoothness, it's a simple matter to add as many power strokes as may be needed, with the unique and valuable benefit that every cyclic set can be generating optimal waveforms.

FIGS. 7B and 7C show details which are either hidden or difficult to see in FIG. 7A. In FIG. 7B, hot-side piston pivot arm 21 engages with hot-side crankpin 22, which is offset from the crankshaft rotation center point through crankpin radius 23. Meanwhile, In FIG. 7C, cold-side piston pivot arm 24 engages with cold-side crankpin 25, which is offset from the crankshaft rotation center point through crankpin radius 26.

The engine arrangement shown in FIG. 7A can be altered to further reduce the thermal losses, by shifting the kinematic linkages currently shown between the two heat exchangers to a plane above or below the heat exchangers. This would have the practical benefits of allowing a single input of hot thermal fluid to heat both of the heaters rather than only one, and similarly allow a single input of cold thermal fluid to cool both of the coolers. A further benefit would be to further increase the specific power of the engine, in that the kinematics could fit within a narrow plane above the engine, occupying a very small volume, while allowing the heat exchangers to be extended to the point where they almost fill the whole volume between the two current heat exchangers. The insulation which is currently between the kinematic mechanism and the heat exchangers could be mostly or completely eliminated, and the heat exchangers for the left and right hand sides brought much closer together, filling the available space.

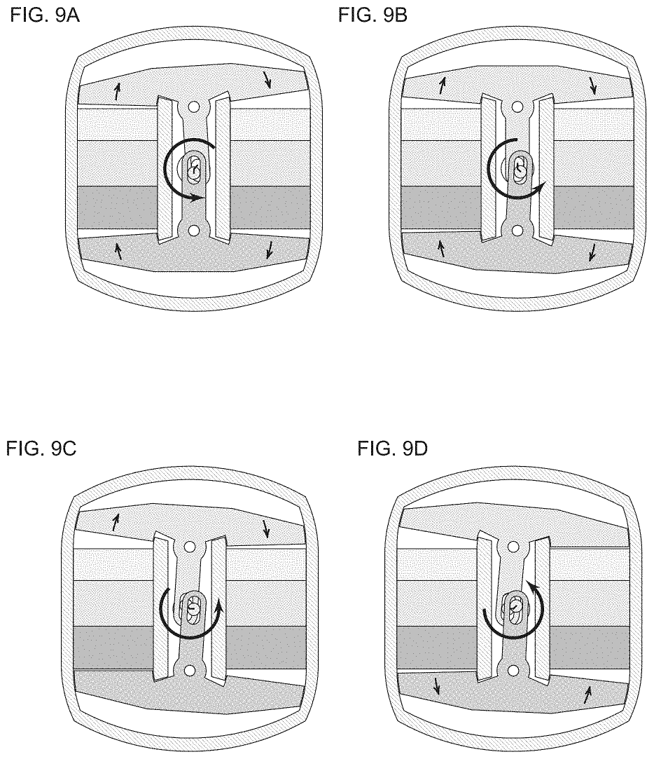

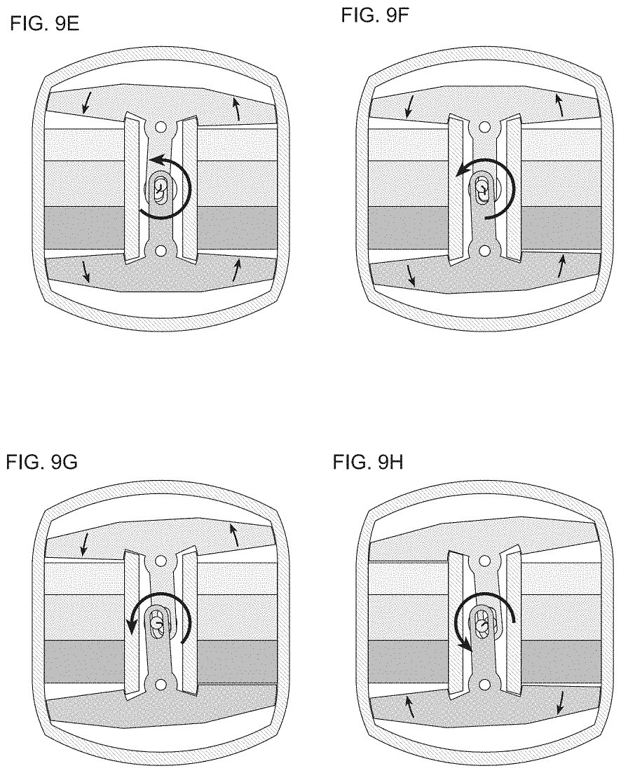

FIGS. 9A-9H illustrate the step-by-step motions of the simple mirrored engine with rotary pistons shown in FIG. 7A.

FIGS. 9A through 9C illustrate a gradual heating cycle in the left-hand cyclic set, and a gradual cooling cycle in the right hand cyclic set. This corresponds to the volumetric motions apparent in the waveforms of FIG. 3 at angles between 180° and 315° for the left-hand cyclic set, and 000° to 135° for the right hand cyclic set.

Between FIGS. 9C and 9D, the cyclic set on the left of the two figures goes through a power stroke, with both pistons moving so as to expand the expansion and compression spaces a bit, while the cyclic set on the right goes through a compression stroke. This corresponds to the volumetric motions apparent in FIG. 3 at angles between 315° and 360° for the left side cyclic set, and 135° to 180° for the right side.

FIGS. 9E through 9G illustrate a gradual cooling cycle in the left-hand cyclic set, and a gradual heating cycle in the right hand cyclic set. This corresponds to the volumetric motions apparent in FIG. 3 at angles between 000° to 135° for for the left-hand cyclic set, and 180° to 315° for the right hand cyclic set.

Between FIGS. 9G and 9H, the cyclic set on the left of the two figures goes through a compression stroke, while the cyclic set on the right goes through a power stroke. This corresponds to the volumetric motions apparent in FIG. 2 at angles between 135° and 180° for the left side cyclic set, and 315° and 360° for the right side.

Thus the cyclic set on the left hand sides of FIGS. 9A-9H goes through the phases of heating, expansion, cooling and compression, in that order. Meanwhile, the cyclic set on the righthand sides of these same figures goes through the phases of cooling, compression, heating and then expansion, in that order. And due to the near-optimal parameters designed into this particular engine, all of these changes are in synch with the waveforms of FIG. 3, matching the measured optimum parameters from the Vaizey-Larque test engine.

### Balanced Engine and Other Embodiments

Engine vibration is prevalent in almost every type of engine, but the energy that vibrates the engine represents a loss, decreasing engine efficiency, and vibrations sometimes create serious problems. Engines which generate a minimum or even zero vibrations are clearly advantageous.

Since engine vibrations are induced by imbalanced motions of some kind within the engine, the best way of balancing such vibrations is to add additional components which can undergo equal and opposite motions.

FIG. 5E illustrates a simple method that can work well for any engine with linear pistons arranged in parallel. By positioning an additional reflected copy of the same engine, adjacent to the first and at a phase shift of 180 degrees relative to the first, the pistons in the new engine will move in ways that will balance the motions of the first engine. While it's also possible to balance an engine by moving counterweights, adding a second engine is preferred because it has the additional benefit of doubling the output power.

One means of balancing the simple mirrored configuration engine with rotary pistons is to take two of the assemblies shown in FIG. 7A and stack one of them on top of the other in a double-decker arrangement as shown in FIG. 7D. In order to get the torques to cancel each other out, the crankpins for the upper assembly need to be arranged with a 180° phase shift relative to the crankpins for the lower one. Thus any rotation of pistons in the upper assembly will coincide with an equal and opposite rotation of the pistons in the lower one. It's important with an approach such as this to first balance each of the rotary pistons about its rotation axis. Failure to do this would result in a torque inducing couple, causing vibrations.

A different balancing approach is shown in FIG. 8C, because these rotary pistons would be much more difficult to individually balance about their rotation axes. Even though every motion in these pistons results in not only a rotary torque but also a linear movement, both of these can be cancelled out at once with the arrangement shown. Linkage means would need to be provided to keep the motions of the pistons of the right hand engine 180 degrees out of phase relative to the motions of the left hand engine.

One problematic issue that arises with substantial hot-side engine temperatures is keeping all the engine bearings within a range they can handle. While the extreme compactness of the FIG. 8A engine comes with many advantages, one disadvantage is the proximity of the rotary piston bearings to a number of hot components. In order to keep the bearings cool, FIG. 8B details some features of a design for actively cooling a fixed axle which will be in physical and thermal contact with those bearings. Hollowed-out axle 30 has a deep hole drilled most of the way through it before being welded or otherwise fixedly held in place along the intended axis of the piston. Then pipe 31 is inserted almost all of the way into axle 30, with one fluid connection created for a flow into the space between the two components, and another connection for the fluid flowing back out of pipe 31. After a cooling thermal fluid has been used to absorb and carry away heat from the engine's cooler section, that fluid will still be at reasonable temperatures, so it can also be used to cool the bearings. Flow arrows 32 show the course of the fluid within the axle, cooling the axle enough that it can conduct heat away from rotary bearings 33, positioned near the top and bottom of axle 30. Meanwhile, in order to minimize thermal losses within the piston, insulating fill 35 surrounds and thermally isolates rigid core 34 and all of the cooled components within it from the hot exterior surfaces of the piston.

A simpler but less effective method of cooling the expansion piston bearings would be to position the bearings above and below the main engine chamber, and add conductive bars in thermal contact with those bearings which are also in remote thermal contact with the cold side of the engine. Those conductive bars would naturally need to be well-insulated from all of the relatively hot components along their lengths. Alternatively, if a relatively cool outer engine casing is present in the engine design, then the expansion piston bearings can simply be brought into thermal contact with the outer engine casing.

While the invention has been described hereinabove with reference to some selected preferred embodiments, it should be recognized that the invention is not limited to those precise embodiments. Rather, many modifications and variations would present themselves to persons skilled in the art without departing from the scope and spirit of this invention, as defined in the appended claims.

I claim:

1. A two cycle double-acting Stirling engine comprising:
a first expansion volume modulated by an expansion piston, a first compression volume modulated by a compression piston, and a first working gas circuit including said first expansion and first compression volumes,
a second expansion volume modulated in inverse phase relation by the same said expansion piston, a second compression volume modulated in inverse phase relation by the same said compression piston, and a second working gas circuit including said second expansion and second compression volumes,
a phase offset between the expansion and compression pistons with an effective alpha angle between 100 and 160 degrees,
whereby two Stirling cycles can be generated with internally balanced pressure forces and a minimal number of components while also enabling near-optimal phase angles, yielding improved performance and more robust engine behavior.

2. A two cycle double-acting Stirling engine with rotary pistons comprising:
a first expansion volume modulated by a rotary expansion piston, a first compression volume modulated by a rotary compression piston, and a first working gas circuit including said first expansion and first compression volumes,
a second expansion volume modulated in inverse phase relation by the same said rotary expansion piston, a second compression volume modulated in inverse phase relation by the same said rotary compression piston, and a second working gas circuit including said second expansion and second compression volumes,
whereby two Stirling cycles can be generated with internally balanced pressure forces and a minimal number of components, near-optimal phase angles are enabled, and the rotary pistons allow the overall engine to be more compact than otherwise possible.

3. A four cycle double-acting Stirling engine comprising two double-acting expansion pistons and two double-acting compression pistons, in which each of said double-acting pistons is connected so as to be a member of one matched cyclic set with a given phase angle of 90 degrees or more as well as one mis-matched cyclic set with a supplementary phase angle of 90 degrees or less,
whereby four Stirling cycles can be generated in a new, novel and useful engine configuration, permitting near optimal phase angles to be simultaneously achieved in all four cycles at once.

4. The four-cycle double acting Stirling engine of claim 3 in which said double-acting compression pistons are connected to move as a single double-piston unit, and said double-acting expansion pistons are similarly connected to move as a single double-piston unit, whereby the number of moving parts required to generate four power strokes per revolution is minimized, the pressure forces are internally balanced within the double-piston units, and near-optimal effective alpha angles are supported, offering improved performance and behaviors.

5. The four-cycle double acting Stirling engine as defined in claim 3 or 4 in which all said pistons move in a rotary rather than linear fashion, whereby the compactness of the engine is improved.

6. The double acting Stirling engine as defined in any of claims 1-5 in which at least one of the following engine parameters have been optimized for the characteristics of that particular engine: effective alpha angle, kappa ratio, engine deadspace volume.

7. The double-acting Stirling engine with rotary pistons as defined in claim 2, 5, or 6 in which any or all of said rotary pistons and their associated modulated volumes are formed so as to require only a single set of piston seals per piston, whereby the friction due to the piston seals is reduced and the overall engine can be even more compact.

8. A pair of the four-cycle double-piston Stirling engines as defined in claim 4 or 5, each with an effective alpha angle of 135 degrees, with their motions coupled to maintain a phase offset of 90° between them, whereby the overall Stirling engine will produce 8 power strokes per revolution evenly distributed at 45 degree intervals, yielding a very smooth power output and 8 times the power, with fewer moving parts than would otherwise be required.

9. A cluster of N of the two cycle Stirling engines as defined in any of claim 1, 2, 6 or 7 with their motions linked together at regular phase offset intervals of 180°/N, whereby the overall multi-cycle Stirling engine will produce 2N equally spaced power strokes per cycle with a smoother and more continuous flow of power, the power output will be multiplied by N, and the self-starting characteristics will be dramatically improved.

10. A pair of Stirling engines as defined in any of the claims 1-9, perhaps omitting or substituting some of the linkage means, with a 180 degree phase shift between the two so that the piston motions in the first said engine are substantially balanced by equal and opposite piston motions in the second said engine, whereby the overall engine vibrations are minimized while also doubling the power output.

11. A Stirling engine with rotary pistons as defined in claim 2 or any of claims 5-10 in which the bearings of the rotary expansion piston are substantially cooled through one of the following 3 methods: by arranging the hot expansion piston to rotate about a fixed hollow axle which is actively cooled by a thermal fluid passing through it, by positioning the bearings of said expansion piston so that they are in thermal contact with the relatively cool outer casing of the engine, by positioning the bearings of said expansion piston so that they are in thermal contact with conductive bars which are in turn in thermal contact with the cooler side of the engine, whereby the bearings associated with said piston will be better maintained within reasonable operating temperatures, contributing to the reliability and longevity of said bearings and hence the reliability of the overall engine.
